(19) United States
(12) Patent Application Publication
(10) Pub. No.: US 2017/0209796 A1
(43) Pub. Date: Jul. 27, 2017

(54) HUMAN SOCIAL DEVELOPMENT TOOL

(71) Applicant: International Business Machines Corporation, Armonk, NY (US)

(72) Inventors: Minkyong Kim, Scarsdale, NY (US); Clifford A. Pickover, Yorktown Heights, NY (US); Valentina Salapura, Chappaqua, NY (US); Maja Vukovic, New York, NY (US)

(21) Appl. No.: 15/002,449

(22) Filed: Jan. 21, 2016

(51) Int. Cl. A63H 3/00; A63H 3/40; G09B 19/00

(52) U.S. Cl. CPC A63H 3/003; G09B 19/00; A63H 3/40

(57) ABSTRACT

Aspects relate to human development tools, systems and methods including a body having humanoid features including eyes, a first sensor configured to detect eye contact between a user and the eyes, a feedback device configured to generate an amelioration action, and a control device located within the body, the control device in communication with the first sensor and the feedback device, the control device configured to control the feedback device to generate an amelioration action based on detected eye contact between the user and the eyes.

### BACKGROUND

The present disclosure relates generally to human social development tools and, more specifically, to a doll configured to collect data and provide feedback to track and aid in human social development.

Human development, and particularly childhood development and tracking of such development may aid in enabling children and other persons to become social and/or provide detection of social and/or developmental abnormalities. Tools may be provided to aid in human social development in tracking and monitoring, in assisting in diagnosis of social and/or developmental abnormalities, and/or in providing treatment and/or remedial mechanisms.

For example, autism is a developmental disorder occurring in infants aged up to three, and one in 50 to 60 people develops autism and related disorders. Typical symptoms of autism include impaired communication due to inability to make eye contact, lack of emotional interaction due to an inability to imagine the feelings of others, and display of limited interests and behaviors.

For example, attempts have been made to improve social adjustment of autistic people by early autism diagnosis for early start of remedial education. For example, pediatricians and child psychiatrists have diagnosed autism by observing behaviors of infants and making an evaluation based on their behaviors. However, a shortage of specialists in such diagnosis approach makes early diagnosis practically difficult. Other developmental abnormalities may be subject to similar difficulty in diagnosis.

Further, attempts have been made to provide tools for aiding in treatment and/or teaching of children or other persons with developmental abnormalities.

### SUMMARY

According to embodiments, human development tools, systems and methods including a body having humanoid features including eyes, a first sensor configured to detect eye contact between a user and the eyes, a feedback device configured to generate an amelioration action, and a control device located within the body, the control device in communication with the first sensor and the feedback device, the control device configured to control the feedback device to generate an amelioration action based on detected eye contact between the user and the eyes.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1A depicts a schematic illustration of a human development tool in accordance with an embodiment of the present disclosure;

FIG. 1B depicts a cutaway schematic illustration of the human development tool of FIG. 1A; and

FIG. 1C illustrates a block diagram of a computer system for use in practicing the teachings herein.

### DETAILED DESCRIPTION

Embodiments described herein are directed to providing a tool for aiding in detection and/or treatment of social development abnormalities, childhood development abnormalities, etc., including autism. The difficulty for some autistic children in making eye contact is seen as a challenge for both the autistic child and the parent or other people attempting to communicate with the child. A child with autism may not look people in the eyes, so people may think the child is disengaged from social interactions. This may lead people to disengage from the child, with a cycle of disengagement developing between the child and the other person.

As provided herein, systems and methods of improving or aiding human development and particularly eye contact of a person, such as a child, are provided. In some embodiments, a human development tool (e.g., such as a doll with a humanoid face) is provided. The human development tool may include sensory input and processing (e.g. voice recognition, gesture recognition, eye tracking, etc.). Accordingly, embodiments as provided herein enable a means for detecting a deficit of eye contact between the human development tool (e.g., a doll) and the user (e.g., a child). Further, in accordance with some embodiments, a means for taking an amelioration action in response to a detected deficit is provided. That is, for example, in accordance with some embodiments, the human development tool may provide various actions to encourage, in a kind manner, a child to make eye contact.

Eye contact may be difficult for children suffering from various childhood development abnormalities, such as autism. Further, during a child's early development, establishing eye contact may be beneficial to the child's social health, and thus encouraging eye contact for the child may be advantageous, even if the child does not suffer from a childhood development abnormality. Accordingly, as provided herein, a human development tool is configured to track and encourage eye contact by a child. Various embodiments will be described herein, and may reference an autistic user (e.g., a child with autism), although a user as provided herein may be any child using the tool for developmental purposes and/or any person suffering from various social abnormalities (i.e., the user does not need to be a child).

The difficulty for some children in making eye contact may be seen as a challenge for both the child and the parent or other people attempting to communicate with the child. For example, a child with autism may not look people in the eyes, so people may think the child is disengaged from social interactions, leading the person to disengage from the child.

As noted above, a human development tool is provided herein. The human development tool may include a humanoid face, i.e., having eyes and other features that may be humanoid. Various configurations may be human-like dolls, although other types of human development tools are contemplated, such as teddy bears, other animal-like dolls, and stuffed animals. Of particular note is a human development tool that has eyes or other features that a user may focus on and make “eye contact” with.

The human development tool may include sensory input components and processing components. For example, in accordance with some non-limiting embodiments, the human development tool may include voice recognition, gesture recognition, eye tracking, etc. The combination of the sensory input components and the processing components may provide for a means for detecting a deficit of eye contact between the human development tool and the user. Further, a means for taking or performing an amelioration action in response to a detected deficit may be provided in various embodiments. In some embodiments, the sensory data may be obtained within or at the human development tool, and in some embodiments, a portion of the sensory data may be obtained from a remote location from the human development tool, such as at a speaker located in a room. Further, in some embodiments, analytical processing of information input or sensed by the sensory input components may be performed within the human development tool, may be performed remotely, e.g., in the cloud, or may be a combination of the two. A report may be generated from the information stored on the human development tool and/or in the cloud.

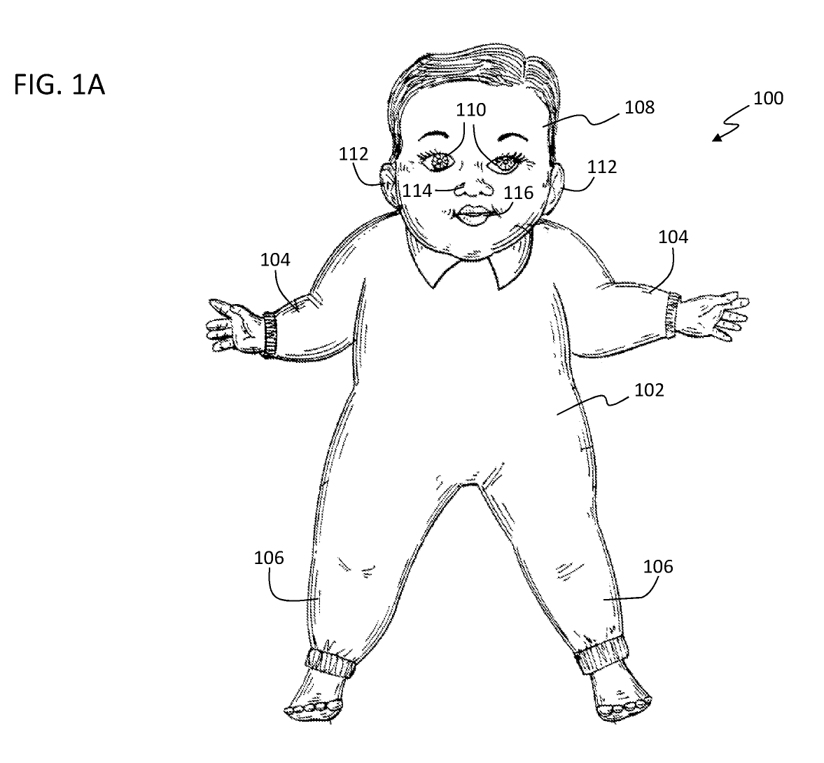

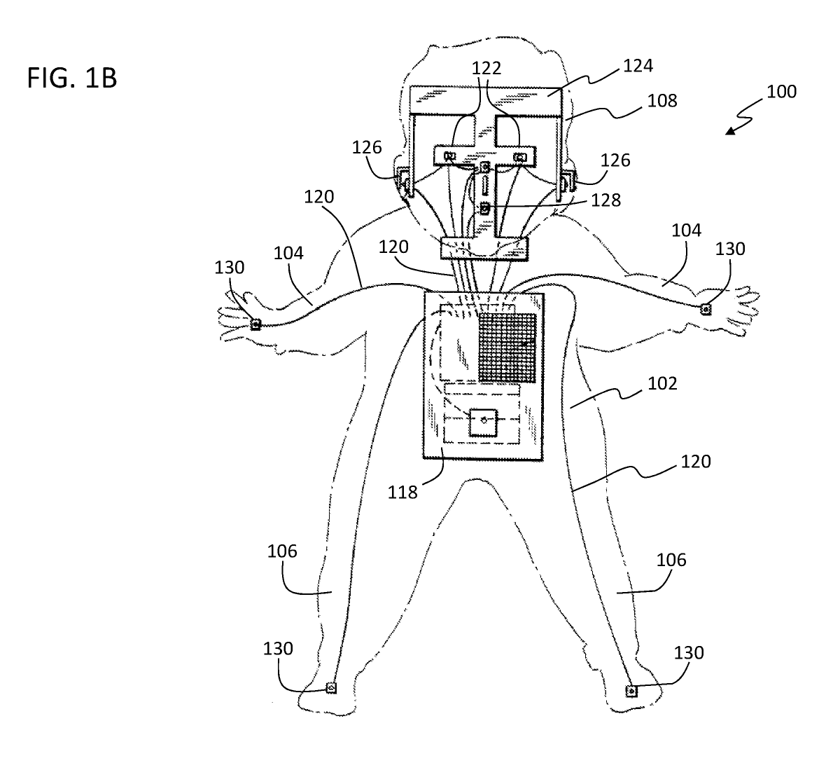

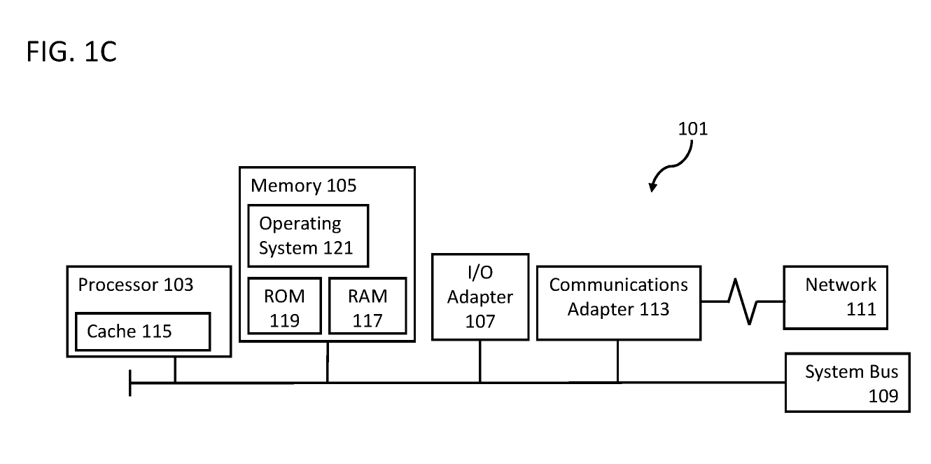

Turning now to FIGS. 1A and 1B, an example of a human development tool in accordance with the present disclosure is shown. As shown, the human development tool 100 is in the form of a human infant having a body 102, arms 104, legs 106, and a head 108. The head 108 is connected to the body 102 by way of a neck. At the ends of the arms 104 may be hands and at the ends of the legs 106 may be feet. The head 108 includes eyes 110, ears 112, a nose 114, and a mouth 116. Accordingly, the human development tool 100 is a substantially humanoid doll, although, as noted above, human development tools in accordance with the present disclosure may take the form of stuffed animals or other types of dolls. However, a primary feature to be included in any human development tool in accordance with embodiments herein is a pair of eyes which may be focused on by a user. That is, a feature for eye contact should be present in embodiments as provided herein.

The features shown in FIG. 1A define an exterior of the human development tool 100. The exterior may be a surface, surfaces, and/or features that a user may interact with and touch. The exterior of the human development tool 100 may be covered by any conventional material used for stuffing and covering dolls, stuffed animals, and/or toys. Further, stuffing materials may be contained within the exterior to provide padding, cushioning, and/or durability to the human development tool 100.

For example, in one non-limiting example embodiment, the exterior of the head 108, hands, and feet may be made from a suitable, flesh-colored flexible polymeric material, such as polyurethane or polyvinyl polymer or co-polymer, and the body 102, arms 104, and legs 106 may be stuffed with a non-flammable, polymeric fiber-fill material, such as a spun or cut polycarbonate. The material that comprises the outer surface or “skin” of head 108 of human development tool 100 may be made of a flesh-colored, semi-rigid polymeric material, such as rotocast soft polyvinyl chloride (commonly known as “PVC”) and may be set around an injection-molded head frame made from, for example, non-toxic rigid polymer such as, for example, acrylic butylstyrene (known as “ABS”).

Eye blinking and eye movements of the eyes 110 may optionally make use of a front shell and a rear casing and an eyeball having a trunnion mounting means so as to be rotative between two or more positions. A weight may be fastened to the eyeball to rotatively bias the eyeball to a position responsive to a respective position of the human development tool 100. The eyeball may have a cam follower, an actuator comprising a cam having angularly related edges, and a means for mounting the actuator for reversible oscillating movement with respect to the eyeball. One such cam edge may be drivingly engageable with the cam follower when moving toward the eyeball and the other cam edge may be drivingly engageable with the cam follower when moving in a reversed direction away from the eyeball. The eyeball may be rotated by movement of the actuator in either direction of motion thereof to achieve a double blinking effect.

In some embodiments, the eyes 110 may be purely electronic, e.g., in the form of small LCD or other kinds of displays. Further, the human development tool 100 may have lips that move as speech sounds are produced from a speaker (e.g., feedback device 128 described below).

The human development tool 100 may include internal components that may enable sensory data input, sensory data collection, and/or sensory data processing in addition to providing mechanisms for performing feedback or actions that may be recognized by a user. For example, electronics, electro-mechanical components, microprocessors, memory, and/or power sources may be installed and housed within the human development tool 100.

For example, with reference to FIG. 1B, an example internal configuration of the human development tool 100 is shown. FIG. 1B shows a cutaway schematic illustration of the human development tool 100 of FIG. 1A revealing the placement of various electronic and/or mechanical features of the human development tool 100. A control device 118 may be located within the body 102 of the human development tool 100. One or more wires 120 may be configured to operably and/or communicably connect the control device 118 with one or more sensors and/or feedback devices. The sensor(s) may be configured to detect sensory input.

For example, optical sensors 122 may be located on a frame 124 within and/or on the head 108 of the human development tool 100 and correspond with the eyes 110. Further, audio sensors 126 may be located on a portion of the frame 124 and correspond with the ears 112. An audio feedback device 128, such as a microphone, may correspond with the mouth 116. Additional sensors and/or feedback devices 128 may be located in the extremities of the human development tool 100, such as in the hands, arms, legs, and/or feet of the human development tool 100. Further, additional sensors and/or feedback devices may be located at various other locations of the human development tool 100 or even located remote from the human development tool 100.

In some embodiments, the optical sensors 122 may be sensors that are sensitive to visible light, infrared light, or other parts of the optical spectrum. In some embodiments, the optical sensors 122 may be cameras, and further, in some embodiments, the optical sensors 122 may be configured as part of or embedded with the eyes 110 of the human development tool 100. The audio sensors 126 may be microphones, and in some embodiments, may be mounted within the ears 112 of the human development tool 100. Those of skill in the art will appreciate that the location of the sensors may not be limited as described and shown. For example, an optical sensor may be located within the forehead of the human development tool 100, and is configured such that it can detect eye contact of a user with the eyes 110 of the human development tool 100. Further, audio sensors are not limited to be located within the ears 112, but rather may be located at other positions near, on, or within the human development tool 100 and/or remote from the human development tool 100.

For example, the eyes 110 (and the sensors 122) may be configured to detect the amount of eye contact a user has with the human development tool 100. The human development tool 100 may include, but is not limited to an eye-gaze point detection unit that detects a line-of-sight direction of the user looking at the target (e.g., the eyes 110); a color camera that takes an image of the user; a pupil position detection unit that measures a pupil coordinate of the user; and/or a data analysis unit that calculates a relationship between a line-of-sight direction of the user and a pupil position of the user using a line-of-sight direction and a pupil coordinate and thus output a relationship along with an image of the user.

The wires 120 may transmit information, data, and/or signals between the sensors 122, 126, 130 and feedback device 128 and the control device 118. The control device 118 may include one or more processors, memory devices, power sources, or other electronic devices. As such, in some embodiments, the control device 118 may be a printed circuit board with a processor and memory that are in communication with the sensors 122, 126, 130 and the feedback device 128.

For example, turning to FIG. 1C, a block diagram of a computing system 101 (hereafter “system 101”) for use in practicing the embodiments described herein is shown. The system 101 may be configured as the control device 118. The methods and processed described herein can be implemented in hardware, software (e.g., firmware), or a combination thereof. In an exemplary embodiment, the methods described herein may be implemented in hardware, and may be part of the microprocessor of a special or general-purpose digital computing system.

In the non-limiting embodiment of FIG. 1, in terms of hardware architecture, the system 101 includes a processor 103. The system 101 also includes memory 105 coupled to the processor 103, and one or more input and/or output (I/O) adapters 107, that may be communicatively coupled via a local system bus 109. The memory 105 may be operatively coupled to one or more internal or external memory devices accessed through a network 111. A communications adapter 113 may operatively connect the system 101 to through the network 111 or may enable direct communication between the system 101 and a remote device (e.g., a smartphone, tablet, local computer, etc.).

The processor 103 may be a hardware device for executing hardware instructions or software that may be stored in a non-transitory computer-readable memory (e.g., memory 105) or provided from an external source through the network 111. The processor 103 can be any custom made or commercially available processor, a central processing unit (CPU), a plurality of CPUs, an auxiliary processor among several other processors associated with the system 101, a semiconductor based microprocessor (in the form of a microchip or chip set), a macroprocessor, or generally any device for executing instructions. The processor 103 can include a memory cache 115. The processor 103 may be configured to perform sensory processing.

The memory 105 can include random access memory (RAM) 117 and read only memory (ROM) 119. The RAM 117 can be any one or combination of volatile memory elements (e.g., DRAM, SRAM, SDRAM, etc.). The ROM 119 can include any one or more non-volatile memory elements (e.g., erasable programmable read only memory (EPROM), flash memory, electronically erasable programmable read only memory (EEPROM), programmable read only memory (PROM), tape, compact disc read only memory (CD-ROM), disk, cartridge, cassette or the like, etc.). Moreover, the memory 105 may incorporate electronic, magnetic, optical, and/or other types of non-transitory computer-readable storage media. As will be appreciated by those of skill in the art, the memory 105 can have a distributed architecture, where various components are situated remote from one another, but can be accessed by the processor 103.

The instructions in the memory 105 may include one or more separate programs, each of which comprises an ordered listing of computer-executable instructions for implementing logical functions. In the example of FIG. 1C, the instructions in the memory 105 may include a suitable operating system 121. The operating system 121 can control the execution of other computer programs and provide scheduling, input-output control, file and data management, memory/storage management, communication control, and related services. For example, the operating system 121 may be an operating system for a human development tool that includes the processor 103 and other associated components as shown and described in system 101.

The I/O adapter 107 can be, for example but not limited to, one or more buses or other wired or wireless connections, as is known in the art. The I/O adapter 107 may have additional elements, which are omitted for simplicity, such as controllers, buffers (caches), drivers, repeaters, and receivers, to enable communications. The I/O adapter 107 may be operably and/or communicably connected to the sensors 122, 126, 130 and the feedback device 128.

As noted, the system 101 may include a communications adapter 113 for coupling to the network 111 or coupling the system 101 to a local device, such as a smartphone, tablet, local computer, etc. As such, in some embodiments, the communications adapter 113 may be a wireless connection device that may enable wireless communication. For example, in some embodiments, the communications adapter 113 may enable Bluetooth® communication and/or NFC communications. Further, in some embodiments, the communications adapter 113 may enable Wi-Fi or other internet communications. Further, in some embodiments, wired communication may be enabled through the communications adapter 113. As will be appreciated by those of skill in the art, various combinations of communications protocols may be used without departing from the scope of the present disclosure.

The network 111 can be an IP-based network for communication between system 101 and any external device(s). The network 111 enables transmissions of data between the system 101 and external systems. In a non-limiting embodiment, the network 111 can be a managed IP network administered by a service provider. The network 111 may be implemented in a wireless fashion, e.g., using wireless protocols and technologies, such as WiFi, WiMax, etc. The network 111 can also be a packet-switched network such as a local area network, wide area network, metropolitan area network, Internet network, or other similar type of network environment. The network 111 may be a fixed wireless network, a wireless local area network (LAN), a wireless wide area network (WAN) a personal area network (PAN), a virtual private network (VPN), intranet or other suitable network system.

In some embodiments, the instructions in the memory 105 may further include a basic input output system (BIOS) (omitted for simplicity). The BIOS is a set of essential routines that initialize and test hardware at startup, start the operating system 121, and support the transfer of data among the operatively connected hardware devices. The BIOS may be stored in the ROM 119 so that the BIOS can be executed when the system 101 is activated. When the system 101 is in operation, the processor 103 may be configured to execute instructions stored within the memory 105, to communicate data to and from the memory 105 and/or remote devices through the network 111, and to generally control operations of the system 101 pursuant to the instructions.

The sensory processing may include natural language processing of a vocal output of a user, eye tracking of the user, responsiveness to touch of the user, gesture tracking of the user, amount of eye contact of the user, and facial expressions of the user. That is, the human development tool 100 may be configured to receive and track input, actions, and features of a user. The human development tool 100 may further record and/or track the collected associated sensory data.

The sensors 122, 126, 130 of the human development tool 100 may be configured to detect multiple inputs including, but not limited to, eye contact, voices (sounds), facial expressions, and touch. As will be appreciated by those of skill in the art, various embodiments of the present disclosure may have sensors configured to sense various types of social communication and developmental aspects thereof. For example, tracking the communication skills including looking (e.g., eye contact), vocalizing, and smiling at others may enable tracking of social development of a user of the human development tool 100.

The sensory information detected and/or collected by the sensors 122, 126, 130 within the human development tool 100 (and/or other sensors located within, on, and/or remote from the human development tool 100) may be processed and/or stored on the human development tool 100. For example, the sensory information may be processed by the processor 103 and/or the sensory information may be stored in the memory 105. Additionally, or in the alternative, the sensory information may be transmitted through the communications adapter 113 and/or over the network 111 to a remote storage and/or processing device.

The storage of the sensory information may enable tracking and analysis of the development of the user. For example, the sensory information may include tracking duration of eye contact, eye contact made in response to an action by the human development tool 100 (e.g., the human development tool 100 making a sound or statement), amount of pressure applied by the user to the human development tool 100 (e.g., hugging), tracking of sounds made by the user, etc. The stored sensory information may be used to generate a history of the actions and/or interactions of the user with the human development tool 100. From the history, analysis may be made regarding a user's social development and/or interactions. For example, by tracking and analyzing a history of sensory information, a determination may be made regarding abnormal development and/or a diagnosis of a condition (e.g., autism) may be made.

The processing of the sensory information may be used for real-time analysis or analysis of a history of sensory information. The processing may include comparing the collected sensory information with known trends and/or known data to assist in diagnosis and/or tracking of a user's social development. Further, in accordance with some embodiments, the processing may include converting and/or formatting the sensory information into packets or other data elements that may be transmitted and/or communicated from the human development tool 100 to another device (e.g., a connected smartphone, the cloud, etc.).

Furthermore, the processing of the sensory data may enable the human development tool 100 to perform amelioration actions. That is, the processing of the sensory information may enable the human development tool 100 to react to and/or respond to the user, and particularly may respond to specific detected sensory information. For example, the processor 103 may be configured to receive the sensory information from the sensors 122, 126, 130, and from the sensory information, the processor 103 may determine that the user performed some particular action (e.g., maintained eye contact for a particular duration). From this, the processor 103 may be configured to control the feedback device 128 to perform an amelioration action that acknowledges and/or rewards the user.

The amelioration action may take many forms. For example, the amelioration action may include a noise such as a laugh or statement congratulating the user. That is, the amelioration action may be an action performed by the human development tool 100 that is encouraging and/or rewarding to the user. Such amelioration action may thus further encourage the user to behave in the detected manner. That is, the amelioration action may be designed to encourage and reinforce particular user behavior. Other amelioration actions may include, but are not limited to, clapping, hugging, waving, blinking, smiling, and speaking words of encouragement. For example, the human development tool 100 may speak words (e.g. “Look at my eyes for a moment.”).

The amelioration action may be carried out using one or more feedback devices, including, but not limited to, the feedback device 128. The feedback device may include a microphone for speech or noise generation, movable limbs, movable and/or color changing eyes, etc. In addition to providing positive feedback to the user, the feedback devices (controlled by the controller 118) may be configured to prompt a user to perform a specific action. For example, the eyes 110 may change colors to attract the attention of the user and thus encourage or teach the user to make eye contact. Similarly, eyebrows located on the head 108 of the human development tool 100 may move to call attention to eyes 110 of the human development tool 100. Further, in some embodiments, the arms 104 of the human development tool 100 may make gestures to eyes 110. The eyes 110 may blink or wink at a controlled rate and speed, and the eyes 110 may move. Such actions may encourage a user to notice the eyes 110 of the human development tool 100.

Furthermore, the amelioration action may be performed in response to a deficit detected. For example, if the human development tool 100 determines that the user has failed to make eye contact for a particular duration, the human development tool 100 may perform the amelioration action to encourage the user to take a particular action. That is, in one non-limiting example, if eye contact is not made between the user and the human development tool 100 for a predetermined duration, the human development tool 100 may point at the eye 110 and audibly ask the user to look into the eyes 110 of the human development tool 100.

In some non-limiting embodiments, the amelioration action may involve a pause by the human development tool 100 before responding to the user. The pause may be sufficient to coax the user to glance at the head 108 and/or the eyes 110 to see whether the human development tool 100. When the user looks at the human development tool 100, the human development tool 100 may be configured to respond immediately and praise and/or reward the user for making eye contact. In some non-limiting examples, the praise or reward may be a statement such as “I like how you're looking at me.”

Thus, in one example, if eye contact between the user and the human development tool 100 is detected for a duration D that exceeds a threshold T per unit time (D>T), human development tool 100 may perform an amelioration action. Such amelioration action may be a statement of “I like how you're looking at me.” Similarly, for example, if eye contact is made quickly by the user, the human development tool 100 may offer praise or other feedback. Further, the human development tool 100 may be configured to attempt to increase a duration of eye contact by the user. In such configurations, the human development tool 100 may ask the user to maintain eye contact with human development tool 100 and may wait a few moments before giving the user what the user wants.

In another example of an amelioration action, the human development tool 100 may attempt to engage the user with specific interests to the user. For example, the human development tool 100 may be configured to engage in a discussion of a particular TV show or a collection of trains. Thus, the human development tool 100 may be configured with particular, detailed interactions with the user. Such interaction may be controlled remotely from a computer, smartphone, etc., from the onboard controller, and/or a combination of the two.

In another embodiment, the human development tool 100 may hand over communication/action patterns to surrounding devices and pass control of encouraging user behavior, e.g., control of amelioration actions. In one non-limiting embodiment, the human development tool 100 may be configured to include an avatar. The avatar may act on behalf of the human development tool 100 when the human development tool 100 is not physically present with the user. For example, the avatar may be an interactive feature on a smartphone, tablet, computer, etc., that is integrated with the human development tool 100 and the tracking and monitoring system thereof.

As noted, the amelioration action is in the form of a request to the user, such as asking the user to look into the eyes 110 of the human development tool 100. The requests made by the human development tool 100 can become more complicated over time, as the user progresses, to help further development and/or track levels of social interaction of the user. For example, initially the human development tool 100 could ask a user to remove hair from either the user's face or the face of the human development tool 100. The user's progress can be tracked over time, by measuring how quickly and successfully the user performs a particular action. As noted, the human development tool 100 may provide an incentive when the user looks at the eyes when the user talks to the human development tool 100 and as the human development tool 100 responds (e.g., pointing to the user, conducting pleasing conversation to the user, enabling access to additional functionality of the human development tool 100, and/or information access, etc.). For example, if an eye contact duration D exceeds a predetermined threshold T per unit time (D>T), then the human development tool 100 may access a database of information on trains, a topic that interests the user. The human development tool 100 can learn which actions are most useful for encouraging eye contact.

In accordance with some embodiments, the human development tool 100 may perform an action to direct the user's attention. For example, the human development tool 100 may move an arm or hand to touch the corner of an eye of the human development tool 100. Such motion may start within the user's range of sight, such that the user may see the action.

Further, in accordance with some embodiments, the human development tool 100 may be configured to request a user to perform a certain action which brings user's attention to vicinity of the eyes 110 of the human development tool 100. For example, such an action may be a statement of “pull my ear,” or “remove my hair from my face,” wherein a user will be prompted to focus on the head 108 of the human development tool 100. The requested actions may have an added benefit of exercising user's motor skills. However, such requests may be fulfilled without fine motor skills, for example by swiping a user's hand over the face of the human development tool 100. Further, in some embodiments, the requests can become more complicated over time, as the user progresses, to help further development. For example, initially the human development tool 100 may be configured to ask a user to remove hair from the face of the human development tool 100. The user's progress can be tracked over time, by measuring how quickly and successfully the user performs a requested action. Once it is determined that the user may have mastered some specific movement(s), the request may be changed and may require a more complicated movement of a user's hand, such as pencil- or tripod-grip. Further, in some embodiments, the progression may be from removing hair from a face of the human development tool 100 to requesting a user to pull an ear 112 of the human development tool 100.

Additionally, in accordance with some embodiments, an option may be provided to offer an incentive to the user when the user completes certain actions. For example, if a user makes eye contact with the human development tool 100, the human development tool 100 can ask for a hug. In another example, the human development tool 100 may providing audible praise, such as “you looked at me very nicely, give me a hug.”

As noted above, in accordance with embodiments provided herein, a human development tool may be configured to initiate actions and collect sensory data. The sensory date may include, but is not limited to: eye contact of a user; facial action(s) and/or response(s) (e.g., smiles when smiled at); response to the user's name; eye movement when following objects visually and/or eye movement when something is pointed at; use of gestures to communicate (e.g., pointing or waving goodbye); response to noises to get the attention of the user; initiation and/or response to cuddling (e.g., hugging a doll); imitation by the user of movements and/or facial expressions of a doll; etc.

In accordance with some embodiments, processing associated with inputs that may require immediate responses or reactions may be processed locally (e.g., either on the control device 118 directly or on a local server/mobile device that is in communication with the human development tool 100). Further, in some embodiments, analysis of collected sensory data may be performed at a remote computer or processor that may be provided with the sensory data through data transmission over the internet or a local wired or wireless connection. For example, in a cloud processing configuration, a history of a user's interaction with the human development tool 100 can be recorded, tracked, and/or analyzed accounting for a record of historical data over a duration of time, e.g., days, weeks, months, etc. In such configurations, in addition to tracking a user's actions, such as eye contact or touch, the processing may further track a user's response to an amelioration action of the human development tool 100. For example, if the human development tool 100 requests (e.g., verbally or by other action) that a user make eye contact, the human development tool 100 may measure or track a time before eye contact is made and for how long eye contact is made, thus providing additional sensory information (e.g., not only tracking that eye contact was made but also tracking what prompted the eye contact and for how long the eye contact was kept).

In one non-limiting example, the collected sensory data may be tracked and processed to aid in diagnosis of a condition of a user. For example, data tracking, comparison, and/or analysis may be made to determine that a user lacks an anticipated response or particular action or lack of action during interactions with the human development tool 100. For example, a lack of eye contact may be indicative of a social abnormality such as autism. If the analysis detects a potential onset of autism, the human development tool 100 and/or a related service that is related to the human development tool 100 can alert a caregiver or parent of the user, such as in the form of a report. Additionally, various embodiments of the human development tool as provided herein may be configured to help judge and/or track a process of autism within a user (or collectively with a plurality of users) by detecting and analyzing social communication of the users.

In accordance with embodiments provided herein, the human development tool 100 may monitor and learn a user's capabilities over the time and adjust behavior accordingly. Further, the human development tool 100 may be configured to track the context (location, social setting, other people present, communication style, etc.) to provide fine-grained feedback and guidance to the user. Furthermore, a network of AI agents, some of which can be human development tools as provided herein, can in collaborative fashion engage with the user. Further, in such configurations, the human development tool may hand over the communication/action patterns to surrounding devices and pass the control of encouraging user behavior. As noted, an avatar may be provided to act on behalf of the human development tool when the human development tool is not physically present with the user.

Various approaches are possible for estimating a user's cognitive state, so as to provide information in addition to eye contact information. For example, in addition to eye-tracking (e.g., eye contact) embodiments provided herein may incorporate face-tracking technology to read facial expressions of the user. Such configurations may enable sensory data collection related to a user's mood. In another embodiment, electrodermal sensors may be incorporated into a human development tool to measure interest/excitement or over-engagement of a user while playing with a particular human development tool. This may be a useful feature for determining when to perform some kind of action by the human development tool. Further, combinations thereof may be used, such that multiple emotional predictors from different modalities are used, e.g., correlating facial expression analysis with high electrodermal activity. Further, social development skills could be assessed, for example, by measuring stress levels of users while playing social games with the human development tool, using body-worn sensors for measuring respiration and heart rate which may be in communication with the human development tool and/or may transmit information to be correlated with sensory information collected by the human development tool.

The sensors of the human development tool may be configured with computer-aided vision and data collection. For example, such sensors may be configured to monitor non-verbal behavior of a user. By tracking such information, for example, a degree of behavioral disorder and/or abnormality may be identified. Further, age estimation may be incorporated in to various sensory data collections.

Technical effects and benefits include a human development tool configured to track social and/or developmental characteristics of a user. For example, embodiments provided herein may enable early detection of autism. Advantageously, if autism is caught in infancy or during a young age of a user, treatment can take full advantage of a user's young brain and the remarkable plasticity thereof. Although autism may be hard to diagnose before 24 months, symptoms often surface between 12 and 18 months. Accordingly, if signs are detected by 18 months of age, intensive treatment may help to rewire the brain and reverse the symptoms. Accordingly, use of embodiments as provided herein may enable detection of an onset of autism, especially in young children.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGURES illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A human development tool comprising:
a body having humanoid features including eyes;
a first sensor configured to detect eye contact between a user and the eyes;
a feedback device configured to generate an amelioration action; and
a control device located within the body, the control device in communication with the first sensor and the feedback device, the control device configured to control the feedback device to generate an amelioration action based on detected eye contact between the user and the eyes.

2. The human development tool of claim 1, further comprising a second sensor configured to detect sensory input of the user.

3. The human development tool of claim 2, wherein the sensory input is at least one of an audible sound of the user or a touch of the user.

4. The human development tool of claim 1, wherein the body is a body of a doll and the eyes are located in a head of the doll.

5. The human development tool of claim 1, wherein the feedback device is a speaker and wherein the amelioration action comprises words of encouragement or praise.

6. The human development tool of claim 1, wherein the control device comprises a processor configured to perform at least one of natural language processing, eye tracking of a user, responsiveness to touch of the user, gesture tracking of the user, amount of eye contact of the user, or facial expressions of the user.

7. The human development tool of claim 1, wherein the amelioration action is at least one of speaks words, eyes change colors, eyebrows move to call attention to the eyes, gestures to the eyes, pauses before responding to the user, increases a length of eye contact, ask the user to maintain eye contact, engage the user with specific interests, blink or wink at a controlled rate and speed, or move the eyes.

8. The human development tool of claim 1, wherein the control device is configured to provide an incentive when the user looks at the eyes when the user talks to the human development tool and as the human development tool responds.

9. The human development tool of claim 1, wherein the control device includes a processor, memory, and a communications adapter, and information collected by the first sensor may be at least one of stored in the memory or transmitted through the communications adapter to a remote device.

10. The human development tool of claim 1, wherein the control device comprises a processor and memory, the processor configured to learn which actions are most useful for encouraging eye contact of the user.

11. The human development tool of claim 1, further comprising a second sensor, the first and second sensors configured to detect at least one of eye contact, sounds, or facial expressions.

12. The human development tool of claim 1, further comprising an external device in communication with the control device, the external device configured to provide encouraging actions to a user.

13. A system to aid in human social development, the system comprising:
a body having humanoid features including eyes;
a first sensor configured to detect eye contact between a user and the eyes;
a feedback device configured to generate an amelioration action; and
a control device located within the body, the control device in communication with the first sensor and the feedback device, the control device configured to control the feedback device to generate an amelioration action based on detected eye contact between the user and the eyes, the control device including:
a memory having computer readable instructions; and
a processor configured to execute the computer readable instructions, the computer readable instructions comprising:
receiving, by the processor, sensory information from the first sensor;
determining a threshold detection of eye contact is present; and
controlling the feedback device to generate the amelioration action.

14. The system claim 13, the computer readable instructions further comprising recording the received sensory information in the memory.

15. The system claim 13, the control device further comprising a communications adapter, the computer readable instructions configured to transmit the received sensory information to an external device.

16. The system of claim 13, further comprising a second sensor configured to detect sensory input of the user.

17. The system of claim 13, wherein the feedback device is a speaker and wherein the amelioration action comprises words of encouragement or praise.

18. A method of aiding in human social development, the method comprising:
detecting, with a first sensor in a human development tool, sensory input of a user including eye contact data;
determining an amelioration action is to be taken with a control device of the human development tool; and
performing the amelioration action.

19. The method of claim 18, wherein the amelioration action is performed by the human development tool.

20. The method of claim 18, further comprising recording the detected sensory input of the user including the eye contact data.
